(19) United States
(12) Patent Application Publication
(10) Pub. No.: US 2026/0288329 A1
(43) Pub. Date: Sep. 24, 2026

(54) ELECTRONIC DEVICE AND METHOD FOR PROVIDING VIRTUAL KEYBOARD OR RECOMMENDED WORDS ON BASIS OF ONE OR MORE ELEMENTS DISPLAYED ON SCREEN, AND COMPUTER-READABLE STORAGE MEDIUM

(71) Applicant: SAMSUNG ELECTRONICS CO., LTD., Suwon-si (KR)

(72) Inventors: Kyungtak HUR, Suwon-si (KR); Mooyoung KIM, Suwon-si (KR); Hojung CHOI, Suwon-si (KR)

(21) Appl. No.: 19/684,674

(22) Filed: May 21, 2026

Related U.S. Application Data
(63) Continuation of application No. PCT/KR2024/018779, filed on Nov. 25, 2024.

(30) Foreign Application Priority Data
Dec. 20, 2023 (KR) 10-2023-0187782
Feb. 14, 2024 (KR) 10-2024-0020968

(51) Int. Cl. G06F 3/04886; G06F 40/274

(52) U.S. Cl. CPC G06F 3/04886; G06F 40/274

(57) ABSTRACT

An electronic device may include: a display; at least one processor including a processing circuit; and a memory including one or more storage media storing instructions, wherein the instructions may, when executed individually or in any combination, by at least one processor, may cause the electronic device to: display, on the display, a screen generated based on data elements arranged in a hierarchical structure; receive an input for a text input portion in the displayed screen; identify, based on the input, a first data element corresponding to the text input portion; identify a second data element related to the first data element; determine, based on the second data element, a type of text to be input through the text input portion; and display, on the display, a virtual keyboard together with the text input portion of the screen according to the determined type of text.

### CROSS-REFERENCE TO RELATED APPLICATIONS

This application is a continuation of International Application No. PCT/KR2024/018779 designating the United States, filed on Nov. 25, 2024, in the Korean Ministry of Intellectual Property Receiving Office and claiming priority to Korean Patent Application Nos. 10-2023-0187782, filed on Dec. 20, 2023, and 10-2024-0020968, filed on Feb. 14, 2024, in the Korean Ministry of Intellectual Property, the disclosures of each of which are incorporated by reference herein in their entireties.

### BACKGROUND

### Field

The present disclosure relates to an electronic device, a method, and a computer readable storage medium for providing a virtual keyboard or a recommended word based on one or more elements displayed on a screen.

### Description of Related Art

Artificial intelligence is a technology for simulating a neural activity of a person (or an organism), such as perception and/or inference, and may be implemented as hardware, software, or any combination thereof designed to perform computation for simulating the neural activity. Based on the artificial intelligence, an electronic device that provides a virtual keyboard or a recommended word by analyzing a hierarchy for displaying a screen may be provided.

The above-described information may be provided as a related art for a purpose of helping understanding of the present disclosure. No assertion or determination is raised as to whether any of the above-described descriptions may be applied as a prior art related to the present disclosure.

### SUMMARY

According to an example embodiment, an electronic device is disclosed. The electronic device according to an example embodiment may include: a display, at least one processor including processing circuitry, and memory including one or more storage media storing instructions, wherein the instructions, when executed, individually or in any combination, by at least one processor, may cause the electronic device to: display, on the display, a screen generated based on data elements arranged in a hierarchical structure; receive an input to a text input portion in the displayed screen; based on the input, identify a first data element corresponding to the text input portion among the data elements arranged in the hierarchical structure; identify a second data element related to the first data element among the data elements arranged in the hierarchical structure; based on the second data element, determine a type of text to be input through the text input portion; and display, on the display, a virtual keyboard together with the text input portion of the screen according to the determined type of text.

According to an example embodiment, an electronic device is disclosed. The electronic device according to an example embodiment may include: a display, at least one processor including processing circuitry, and memory including one or more storage media storing instructions, wherein the instructions, when executed, individually or in any combination, by at least one processor, may cause the electronic device to: display, on the display, a screen generated based on data elements arranged in a hierarchical structure; receive an input to a text input portion in the displayed screen; based on the input, identify a first data element corresponding to the text input portion among the data elements arranged in the hierarchical structure; identify a second data element related to the first data element among the data elements arranged in the hierarchical structure; determine one or more recommended words related to one or more contents provided by the second data element; and display, on the display, a virtual keyboard including the one or more recommended words together with the text input portion of the screen.

According to an example embodiment, an example method of operating an electronic device is disclosed. The method of operating the electronic device according to an example embodiment may include: displaying, on a display of the electronic device, a screen generated based on data elements arranged in a hierarchical structure; receiving an input to a text input portion in the displayed screen; based on the input, identifying a first data element corresponding to the text input portion among the data elements arranged in the hierarchical structure; identifying a second data element related to the first data element among the data elements arranged in the hierarchical structure; based on the second data element, determining a type of text to be input through the text input portion; and displaying, on the display, a virtual keyboard together with the text input portion of the screen according to the determined type of text.

According to an example embodiment, a non-transitory computer-readable storage medium is disclosed. According to an example embodiment, in the non-transitory computer-readable storage medium storing one or more programs, the one or more programs may include instructions which, when executed by at least one processor, comprising processing circuitry, individually or in any combination, of an electronic device with a display, cause the electronic device to: display, on the display, a screen generated based on data elements arranged in a hierarchical structure; receive an input to a text input portion in the displayed screen; based on the input, identify a first data element corresponding to the text input portion among the data elements arranged in the hierarchical structure; identify a second data element related to the first data element among the data elements arranged in the hierarchical structure; based on the second data element, determine a type of text to be input through the text input portion; and display, on the display, a virtual keyboard together with the text input portion of the screen according to the determined type of text.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various example embodiments.

FIG. 2 is a diagram illustrating an example electronic device for analyzing a hierarchical structure for displaying a screen according to various example embodiments.

FIGS. 3A and 3B are diagrams illustrating example hierarchical structures for displaying a screen of an example electronic device according to various example embodiments.

FIGS. 4A and 4B are diagrams illustrating example operations of an example electronic device according to various example embodiments.

FIGS. 4C and 4D are diagrams illustrating example operations of an example electronic device according to various example embodiments.

FIG. 5 is a diagram illustrating an example operation of an example electronic device according to various example embodiments.

FIG. 6 is a diagram illustrating an example operation of an example electronic device according to various example embodiments.

FIG. 7 is a flowchart illustrating an example operation of an example electronic device according to various example embodiments.

### DETAILED DESCRIPTION

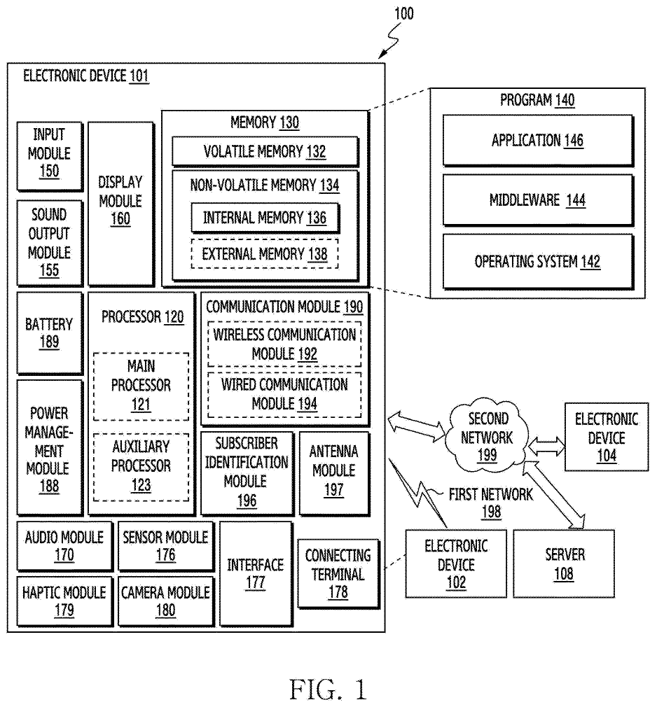

FIG. 1 is a block diagram illustrating an example electronic device 101 in a network environment 100 according to various example embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus,, the processor 120 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

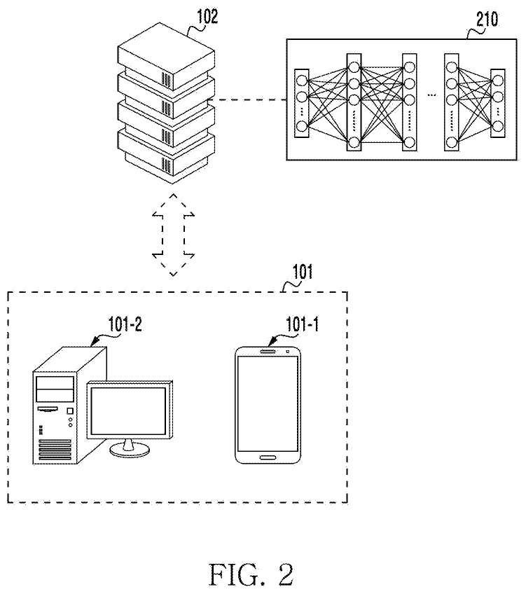

FIG. 2 is a diagram illustrating an example electronic device for analyzing a hierarchical structure for displaying a screen according to various example embodiments.

Referring to FIG. 2, an electronic device 101 may be connected to be communicable with an electronic device 102. The electronic device 102 may include a server (e.g., the server 108 of FIG. 1) of a service provider. The server may include a computer designed to provide a function of the server, such as a workstation. The disclosure is not limited thereto, and the server may include a combination of a personal computer and a software application installed in the personal computer. The server may include a group (or a cluster) of the illustrated workstation and/or personal computer. The server may be configured to execute a software application for providing a service by a service provider for providing the service through a network such as the Internet.

According to an embodiment, the electronic device 101 may include a smartphone 101-1, a smartpad, and/or a tablet PC. The electronic device 101 may include a personal computer such as a desktop 101-2 and a laptop. The disclosure is not limited thereto, and the electronic device 101 may include a smart accessory such as a smartwatch and/or a head-mounted device (HMD) in which an application in which a software keyboard 230 is provided is executable in the electronic device 101.

According to an embodiment, the electronic device 102 may be configured to receive a request for analyzing a hierarchical structure (hierarchy structure) for displaying a screen of the electronic device 101 from the electronic device 101. Based on a request of a user obtained from the electronic device 101 and/or an input (e.g., a user input) input by a community service, the electronic device 102 may perform an operation for displaying a virtual keyboard and/or a keyword related to the user input.

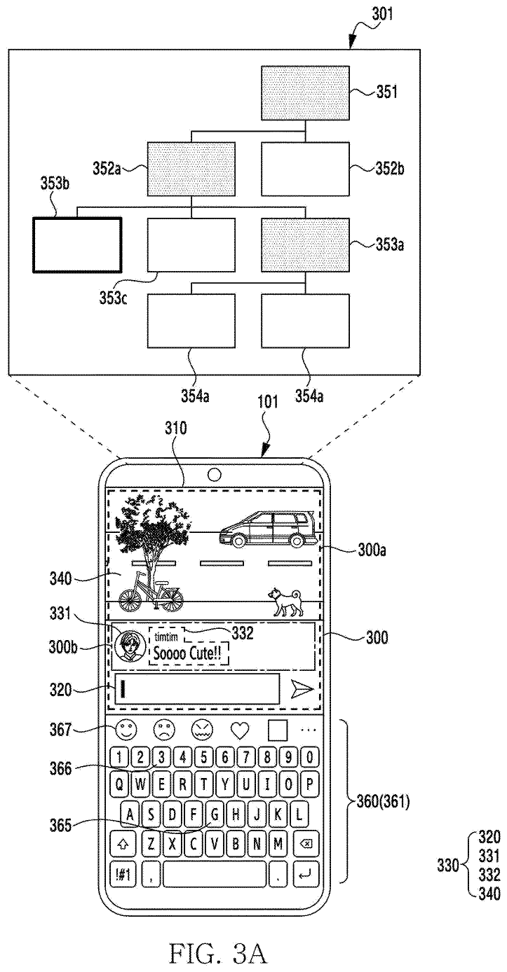

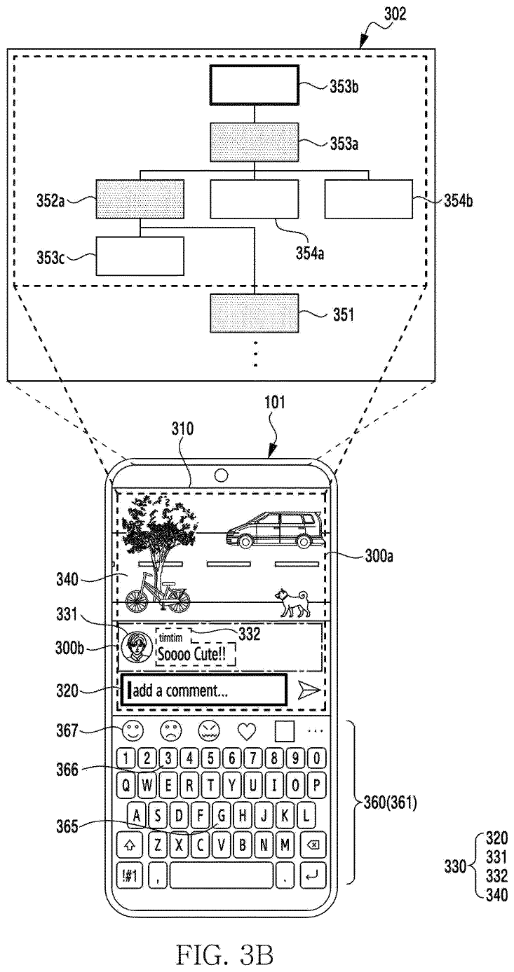

According to an embodiment, a hierarchical analysis model 210 may be provided to the electronic device 102 as a neural network for analyzing the hierarchical structure generated to display the screen of the electronic device 101 to execute a function corresponding to a request from the electronic device 101. The electronic device 102 may be configured to generate a hierarchical structure different from the hierarchical structure or to search a plurality of elements in the hierarchical structure using the hierarchical analysis model 210, based on a user input for hierarchical analysis received from the electronic device 101. For example, the electronic device 102 may regenerate a hierarchical structure using the hierarchical analysis model 210 based on the input for hierarchical analysis received from the electronic device 101. In the present disclosure, when an element is mentioned as regenerating a hierarchical structure for displaying a screen, it may refer, for example, to generating an additional hierarchical structure (e.g., a hierarchical structure 302 of FIG. 3B) different from the hierarchical structure by rearranging data elements in a hierarchical structure (e.g., a hierarchical structure 301 of FIG. 3A) for displaying the screen or modifying a location in the hierarchical structure between the data elements.

The data element in the hierarchical structure (e.g., the hierarchical structure 301 of FIG. 3A or the hierarchical structure 302 of FIG. 3B) may be referred to as any one of a node, a document object model (DOM) element, and a DOM node that configure a portion of the hierarchical structure, but is not limited thereto.

For example, the hierarchical analysis model 210 may be trained based on a weight of a plurality of elements displayed on the screen of the electronic device 101. Based on a text input portion (e.g., a text input portion 320 of FIG. 3A) for receiving a user input among the plurality of elements displayed on the screen of the electronic device 101, the electronic device 101 may be configured to regenerate a hierarchical structure with respect to the text input portion 320 or to perform searching elements displayed around the text input portion using the hierarchical analysis model 210. The hierarchical analysis model 210 may be trained with respect to a distance between a data element corresponding to the text input portion 320 and data elements corresponding to each of the elements around the text input portion 320 in the hierarchical structure for displaying the screen. The electronic device 101 may be configured to detect a corresponding element (e.g., a corresponding element 340 of FIG. 3B) related to the text input portion 320 with respect to relevance of each of the searched data elements for the text input portion 320 using the hierarchical analysis model 210. The electronic device 101 may be configured to identify a data type indicating the corresponding element 340 or to identify information indicated by the corresponding element 340 based on the corresponding element 340 related to the text input portion 320.

For example, a processor 120 may be configured to identify the corresponding element 340 related to the text input portion 320 in the screen using unique values of each of a plurality of elements preset (e.g., specified) for displaying a screen, or to identify the corresponding element 340 related to the text input portion 320 using a pattern of a layout of the screen according to a user input to each of the plurality of elements. The unique values may be provided as a hash table from a database of the electronic device 101 and/or the electronic device 102, but are not limited thereto.

It has been illustrated and described that the hierarchical analysis model 210 is provided through the electronic device 102 distinguished from the electronic device 101, but is not limited thereto. The hierarchical analysis model 210 may be provided to the electronic device 101. For example, the hierarchical analysis model 210 may be driven based on a plurality of parameters included in memory (e.g., the memory 130 of FIG. 1) of the electronic device 101.

According to an embodiment, in a case that the hierarchical analysis model 210 fails to detect another data element related to one data element in the hierarchical structure, it may be retrained through data additionally input to the hierarchical analysis model 210. The hierarchical analysis model 210 being trained through the additional data may be referred to as transfer learning, but is not limited thereto. For example, the hierarchical analysis model 210 may be configured to correct an error in a data value output from the hierarchical analysis model 210 by being trained through federated learning of a plurality of trained models including the hierarchical analysis model 210.

Hereinafter, referring to FIGS. 3A to 6, an operation in which the electronic device 101 provides a virtual keyboard (e.g., a virtual keyboard 360 of FIG. 3A) and/or one or more recommended words related to the text input portion 320 for a user input using the hierarchical analysis model 210 is described in greater detail. Operations illustrated and described in FIGS. 3A and 3B may be performed by the processor (e.g., the processor 120 of FIG. 1) of the electronic device 101.

FIGS. 3A and 3B are diagrams illustrating example hierarchical structures for displaying a screen of an example electronic device according to various example embodiments.

Referring to FIGS. 3A and 3B, an example screen 300 including a plurality of elements 330 may be displayed through a display 310 of an electronic device 101. Operations of FIGS. 3A and 3B may be performed by the electronic device 101 and/or the processor 120 of the electronic device 101 of FIG. 1.

When referring to FIG. 3A, the processor 120 may be configured to generate a hierarchical structure 301 to display the screen 300 including the plurality of elements 330. For example, the hierarchical structure 301 may include a data element 351 corresponding to the screen 300 displayed through the display 310. The hierarchical structure 301 may include a plurality of data elements for displaying the plurality of elements 330 in the screen 300 using the data element 351 as a root data element (root node). For example, the processor 120 may be configured to display the screen 300 generated based on data elements arranged in the hierarchical structure 301. The screen 300 may include the plurality of elements 330 corresponding to each of the plurality of data elements.

According to an embodiment, the processor 120 may be configured to receive a first user input through the text input portion 320 configured to receive a user input among the plurality of elements 330 while the screen 300 including the plurality of elements 330 is displayed through the display 310. For example, the processor 120 may be configured to identify a first user input to the text input portion 320 for inputting text, a number, and/or an emoticon object displayed in the screen 300 (e.g., a touch input to the text input portion 320 in the screen 300). The processor 120 may be configured to, for example, execute a function for inputting text and/or a number in the text input portion 320, based on the first user input to the text input portion 320.

According to an embodiment, the processor 120 may be configured to display the screen 300 generated based on the data elements arranged in the hierarchical structure 301 through the display 310. The processor 120 may be configured to identify a data element 353b corresponding to the text input portion 320 among the data elements arranged in the hierarchical structure 301 based on the first user input to the text input portion 320. For example, the processor 120 may control the display 310 such that the plurality of elements 330 corresponding to each of the data elements in the hierarchical structure 301 are displayed on the screen 300. The processor 120 may be configured to identify the data element 353b in the hierarchical structure 301 corresponding to the text input portion 320 based on the first user input to the text input portion 320 among the plurality of elements 330.

According to an embodiment, the processor 120 may be configured to identify a data element 353c related to the data element 353b corresponding to the text input portion 320 among data elements arranged in the hierarchical structure 301 and/or a hierarchical structure 302. For example, the processor 120 may be configured to identify the data element 353c based on progressively searching the data elements arranged in the hierarchical structure 301 with respect to a hierarchical depth from the data element 353b corresponding to the text input portion 320 using a trained hierarchical analysis model (e.g., the hierarchical analysis model 210 of FIG. 2). A corresponding element 340 corresponding to the data element 353c may be an element having the highest relevance to the text input portion 320 among the plurality of elements 330 displayed on the screen 300.

According to an embodiment, the processor 120 may be configured to identify the data element 353c related to the data element 353b corresponding to the text input portion 320 using the trained hierarchical analysis model (e.g., the hierarchical analysis model 210 of FIG. 2). Each distance between the text input portion 320 and other elements may be checked using an x, y coordinate value of a display region of the display 310 corresponding to each of the one or more elements. The processor 120 may be configured to repeatedly perform detecting one or more elements from the text input portion 320 until the corresponding element 340 related to the text input portion 320 is detected by changing the hierarchical depth from the data element 353b in the hierarchical structure 302. The training of the hierarchical analysis model 210 may be referred to as machine learning, but is not limited thereto.

For example, when referring to FIG. 3A, the processor 120 may be configured to generate the hierarchical structure 301 for displaying the screen 300 including the plurality of elements 330 through the display 310 before the first user input is input through the text input portion 320. The hierarchical structure 301 may include the data element 351 corresponding to the screen 300, a data element 352a corresponding to a region 300a of the screen 300 as a lower data element of the data element 351, and a data element 353a corresponding to a region 300b in the region 300a of the screen 300 as a lower data element of the data element 352a. The hierarchical structure 301 may include a data element 352b corresponding to a virtual keyboard 360 displayed on the screen 300 as a lower data element of the data element 351 for the screen 300. The hierarchical structure 301 may include the data element 353b corresponding to the text input portion 320 displayed in the region 300a as a lower data element of the data element 352a for the region 300a of the screen 300, and the data element 353c corresponding to the corresponding element 340 related to the text input portion 320 displayed in the region 300a. The hierarchical structure 301 may include a data element 354a corresponding to a visual object 331 displayed in a region 300b and a data element 354b corresponding to text 332 displayed in the region 300b, as a lower data element of the data element 353a for the region 300b in the region 300a. However, the above-described embodiment is merely an example, and the disclosure is not limited thereto. The processor 120 may be configured to generate the hierarchical structure 301 to display the plurality of elements 320, 331, 332, and 340 on the regions 300a and 300b of the screen 300 displayed through the display 310 before a user input through the text input portion 320 is identified.

For example, when referring to FIG. 3B, the processor 120 may regenerate a hierarchical structure using the hierarchical analysis model 210 trained based on a weight of the plurality of elements 330 in response to the first user input received through the text input portion 320. For example, when referring to FIGS. 3A and 3B sequentially, based on receiving the first user input to the text input portion 320, the processor 120 may regenerate the hierarchical structure 302 from the hierarchical structure 301 using the data element 353b corresponding to the text input portion 320 as a root data element. For example, based on the first user input to the text input portion 320, the processor 120 may generate the additional hierarchical structure 302 that includes the data elements in the hierarchical structure 301 by modifying the hierarchical structure 301 based on the data element 353b corresponding to the text input portion 320. The data element 353b corresponding to the text input portion 320 in the hierarchical structure 302 may be set as a root data element (root node) of the hierarchical structure 302. The processor 120 may be configured to identify the data element 353c corresponding to the corresponding element 340 related to the text input portion 320 using the regenerated hierarchical structure 302.

For example, when referring to FIG. 3B, the processor 120 may be configured to determine whether a data element (e.g., the data element 353a) having a first hierarchical depth is related to the data element 353b from the data element 353b corresponding to the text input portion 320 among the data elements in the hierarchical structure 302. The processor 120 may be configured to identify the data element as a data element for determining a type of text to be input through the text input portion 320 based on determining that the data element among the data elements in the hierarchical structure 302 is related to the data element 353b. The processor 120 may be configured to determine whether another data element (e.g., the data element 352a, the data element 354a, or the data element 354b) having a second hierarchical depth is related to the data element 353b from the data element 353b based on determining that the data element is not related to the data element 353b. The second hierarchical depth may be greater than the first hierarchical depth.

For example, the processor 120 may be configured to first detect the region 300b corresponding to the data element 353a in the first hierarchical depth from the data element 353b corresponding to the text input portion 320 in the hierarchical structure 301 generated before the first user input is received. The processor 120 may be configured to identify whether the corresponding element 340 related to the text input portion 320 is detected among components, by detecting the components corresponding to lower data elements of the data element 353a. For example, the processor 120 may identify whether the visual object 331 and the text 332 are related to the text input portion 320 by detecting the visual object 331 and the text 332 displayed in the region 300b, the visual object 331 corresponding to the data element 354a and the text 332 corresponding to the data element 354b. The processor 120 may be configured to detect the region 300a corresponding to the data element 352a in the second hierarchical depth greater than the first hierarchical depth from the data element 353a as an upper data element of the data element 353b corresponding to the text input portion 320 in the hierarchical structure 301, by increasing a hierarchical depth, based on identifying that the visual object 331 and the text 332 are not related to the text input portion 320. For example, the processor 120 may identify whether the corresponding element 340 is related to the text input portion 320 by detecting the corresponding element 340 displayed in the region 300a and corresponding to the data element 353c. The processor 120 may be configured to cease detecting the plurality of elements 330 displayed on the screen 300 based on detecting the corresponding element 340 related to the text input portion 320.

For example, the processor 120 may be configured to detect elements corresponding to upper data elements (e.g., the data element 352a and the data element 351) of the data element 353b, by increasing a hierarchical depth from data elements (e.g., the data element 353a) closest to the data element 353b corresponding to the text input portion 320, using the hierarchical analysis model 210, based on the first user input through the text input portion 320. The processor 120 may be configured to efficiently detect the corresponding element 340 related to the text input portion 320, by generating the hierarchical structure 302 for displaying the screen 300 in which the data element 353b corresponding to the text input portion 320 is set as a root data element based on the first user input through the text input portion 320.

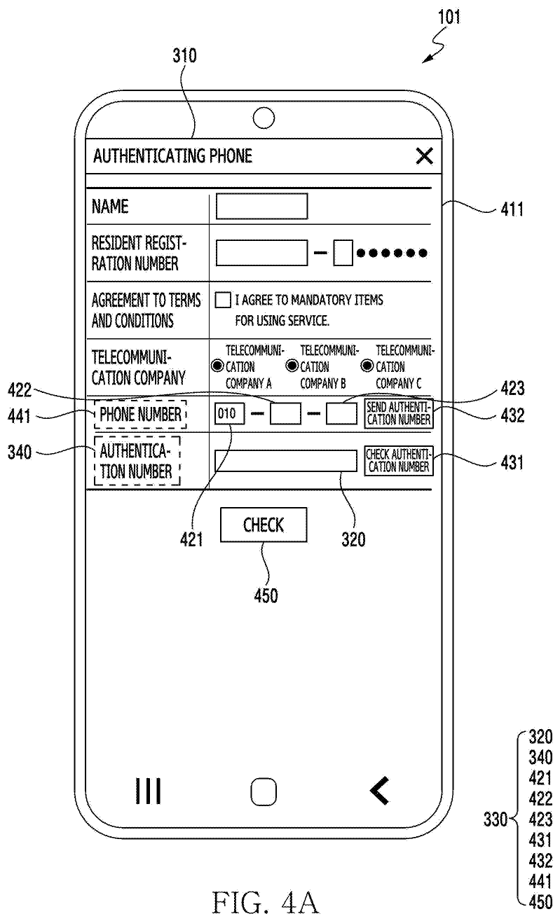

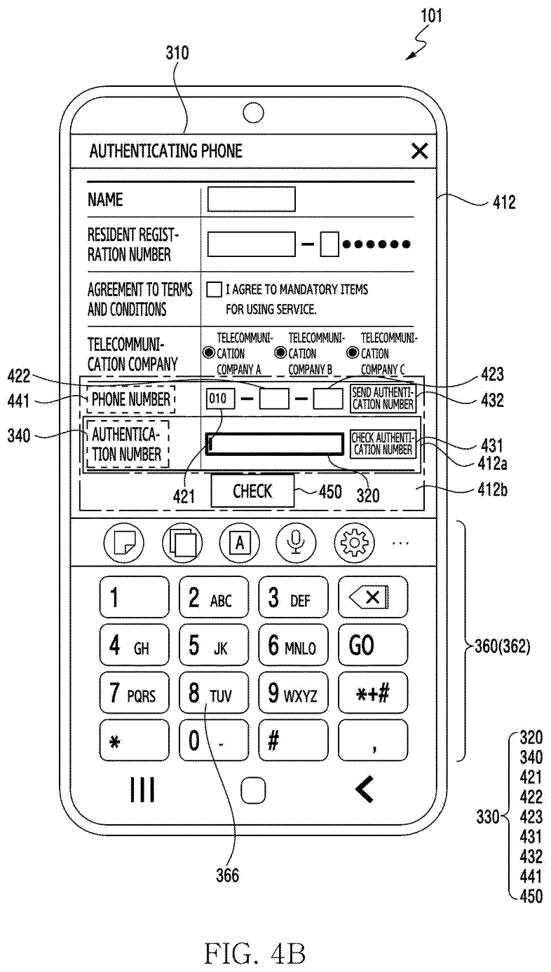

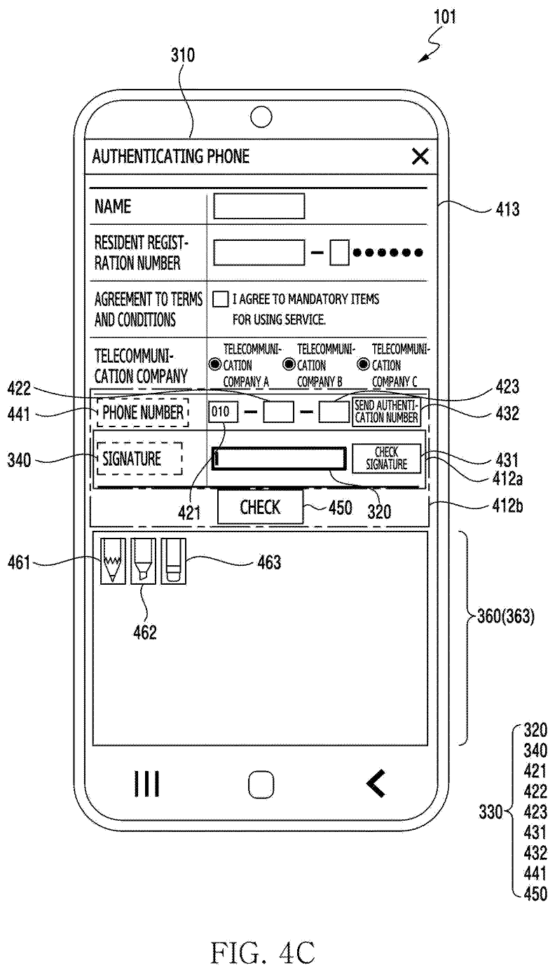

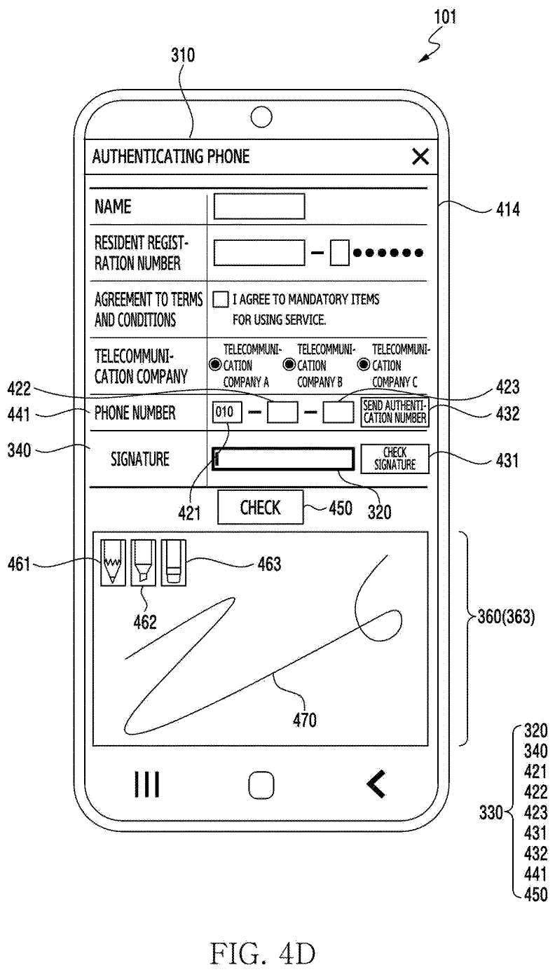

According to an embodiment, the processor 120 may determine a type of text to be input through the text input portion 320 based on identifying the data element 353c related to the data element 353b corresponding to the text input portion 320. For example, the type of text to be input into the text input portion 320 may include at least one of a character, a number, and a combination thereof, but is not limited thereto. The processor 120 may be configured to display the virtual keyboard 360 on the display 310 together with the text input portion 320 of the screen 300 according to the determined type of text. With regard to the processor 120 displaying the virtual keyboard 360 having various layouts according to the determined type of text, it is described in greater detail below with reference to FIG. 4A.

According to an embodiment, the processor 120 may be configured to display the screen 300 on the display 310 by executing a first software application that generates the hierarchical structure 301 and/or the hierarchical structure 302. The processor 120 may be configured to execute a second software application (e.g., a keyboard application) to display the virtual keyboard 360 superimposed in the screen 300 based on the first user input to the text input portion 320. The processor 120 may be configured to identify the data element 353c related to the data element 353b corresponding to the text input portion 320 among data elements arranged in the hierarchical structure 302 generated by the first software application based on the execution of the second software application. For example, the processor 120 may be configured to generate the hierarchical structure 302 in which the data element 353b corresponding to the text input portion 320 is set as a root data element, based on the first user input to the text input portion 320, while the second software application for displaying the virtual keyboard 360 on the display 310 is being executed. Using the hierarchical analysis model 210, the processor 120 may be configured to progressively detect a data element related to the data element 353b among the hierarchical structure 302 using a hierarchical depth. Detecting the data element related to the data element 353b in the hierarchical structure 302 may be performed using the second software application and/or by the second software application, but is not limited thereto.

According to an embodiment, when referring to FIG. 3B, the processor 120 may be configured to identify whether a data type indicating the corresponding element 340 corresponds to text based on identifying the corresponding element 340 related to the text input portion 320 detected through the hierarchical structure 302. Based on identifying that the data type indicating the corresponding element 340 corresponds to text, the processor 120 may be configured to obtain information included in the text (e.g., a meaning of the text or a meaning of one or more words included in the text). For example, the processor 120 may be configured to identify whether a data type indicating the corresponding element 340 corresponds to an image based on identifying the corresponding element 340 related to the text input portion 320 detected through the hierarchical structure 302. Based on identifying that the data type indicating the corresponding element 340 corresponds to text, the processor 120 may be configured to obtain information included in the image (e.g., one or more visual objects included in the image or information indicated by the visual objects). The processor 120 may be configured to display the virtual keyboard 360 and/or one or more recommended words related to the corresponding element 340 and/or the text input portion 320 using the data type indicating the corresponding element 340 and/or the information indicated by the corresponding element 340.

According to an embodiment, based on relevance between a first data element and a second data element determined by the hierarchical analysis model 210, the processor 120 may be configured to identify the second data element using the hierarchical analysis model 210. The relevance may be output from the hierarchical analysis model 210 based on a referential relationship between the first data element and the second data element.

The referential relationship between the first data element and the second data element may be referred to as an example in which the first data element and the second data element partially share data related to each other, or as an indication relationship and/or an association between the first data element and the second data element, and the relevance between the first data element and the second data element may be determined based on the referential relationship, but is not limited thereto.

For example, the processor 120 may be configured to identify the data element 353b and the data element 353c related to the data element 353b using the hierarchical analysis model 210, based on a referential relationship between the data element 353b corresponding to the text input portion 320 and other data elements other than the data element 353b. The processor 120 may be configured to efficiently detect the corresponding element 340 related to the text input portion 320 using the relevance output from the hierarchical analysis model 210 based on the referential relationship.

According to an embodiment, the processor 120 may be configured to determine a type of the virtual keyboard 360 corresponding to the text input portion 320, using the data type indicating the corresponding element 340 related to the text input portion 320 detected through the hierarchical structure 302 and/or the information indicated by the corresponding element 340. The processor 120 may be configured to control the display 310 to display the virtual keyboard 360 having a layout corresponding to the determined type.

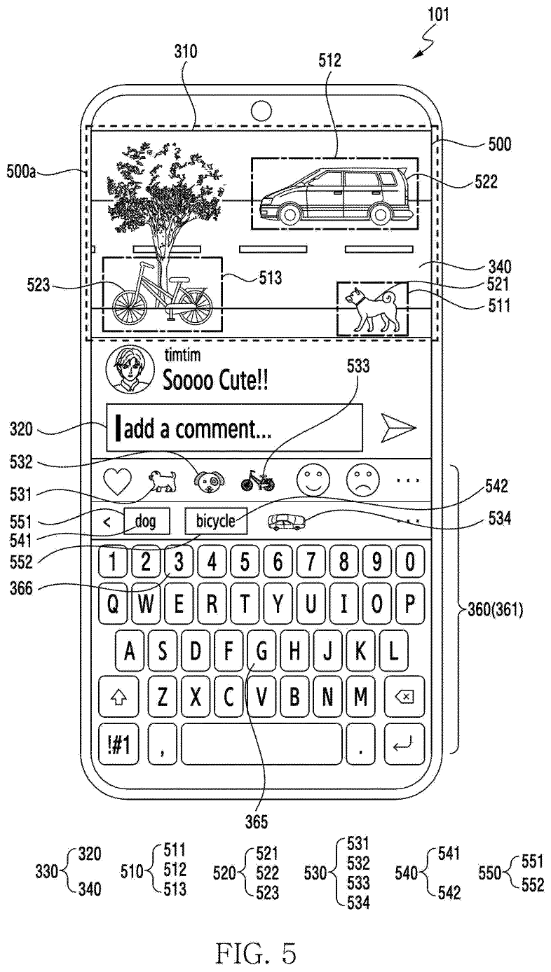

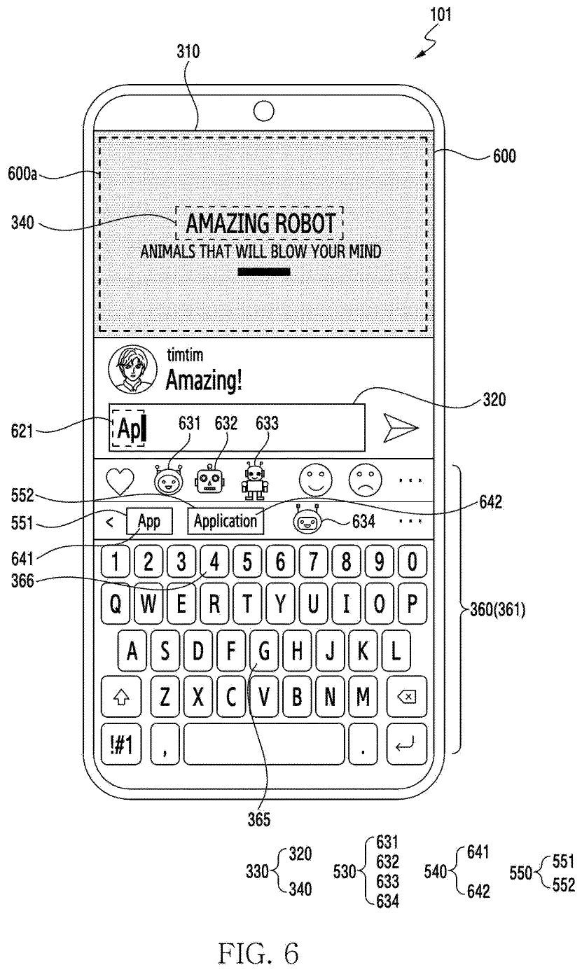

For example, when referring to FIG. 3B, the processor 120 may identify that a data type of the corresponding element 340 related to the text input portion 320 searched through the hierarchical structure 302 is an image. Based on identifying that the data type of the corresponding element 340 is an image, the processor 120 may be configured to display the virtual keyboard 360 corresponding to a first software keyboard 361 including one or more alphabets 365 for inputting text related to the corresponding element 340, a plurality of numbers 366 for visual objects in the corresponding element 340, and one or more emoticon objects 367 for representing the visual objects in the corresponding element 340 using the data type of the corresponding element 340 and/or information indicated the corresponding element 340. An operation of the processor 120 for displaying the virtual keyboard 360 having a layout related to the text input portion 320 using the corresponding element 340 is described with reference to FIGS. 4A to 4D. An operation of the processor 120 for displaying one or more recommended words related to the text input portion 320 using the corresponding element 340 is described in greater detail below with reference to FIGS. 5 and 6.

According to an embodiment, the processor 120 of the electronic device 101 may be configured to efficiently detect the corresponding element 340 related to the text input portion 320 by searching the data element 353c related to the data element 353b using a hierarchical depth from the data element 353b corresponding to the text input portion 320. The processor 120 may be configured to provide the virtual keyboard 360 having a layout related to the text input portion 320 or to display one or more recommended words related to the text input portion 320 through the display 310, by being configured to identify a data type indicating the corresponding element 340 and/or information indicated by the corresponding element 340.

FIGS. 4A and 4B are diagrams illustrating example operations of an example electronic device according to various example embodiments. FIGS. 4C and 4D are diagrams illustrating example operations of an example electronic device according to various example embodiments.

Referring to FIGS. 4A, 4B, 4C, and 4D, example screens 411, 412, 413, and 414 including a plurality of elements 330 may be displayed through a display 310 of an electronic device 101. Operations of FIGS. 4A to 4D may be performed by the electronic device 101 and/or the processor 120 of the electronic device 101 of FIG. 1.

When referring to FIGS. 4A and 4B, the processor 120 may be configured to generate a hierarchical structure for displaying the plurality of elements 330 through the display 310 with respect to a text input portion 320, using a hierarchical analysis model (e.g., the hierarchical analysis model 210 of FIG. 2), based on a first user input to the text input portion 320 among the plurality of elements 330.

For example, the processor 120 may be configured to first detect a region 412a in a screen 412 that corresponds to a data element closest to a data element corresponding to the text input portion 320 and/or elements in the region 412a, based on the first user input input to the text input portion 320 (e.g., a touch input of a user to the text input portion 320). For example, based on the first user input through the text input portion 320, the processor 120 may be configured to detect a corresponding element 340 in the region 412a and a visual object 431 for authentication of text and/or a number input through the text input portion 320. The processor 120 may be configured to obtain a data type indicating the corresponding element 340 and information indicated by the corresponding element 340 based on detecting the corresponding element 340 related to the text input portion 320.

According to an embodiment, the processor 120 may be configured to determine a type of text to be input through the text input portion 320 based on a data element corresponding to the text input portion 320. The processor 120 may be configured to identify a virtual keyboard 360 corresponding to the type of text among virtual keyboards available in the electronic device 101. The processor 120 may be configured to display the virtual keyboard 360 corresponding to the type of text together with the text input portion 320 in a screen displayed through the display 310. The virtual keyboard 360 corresponding to the type of text may be associated with the type of text compared to one or more remaining virtual keyboards among the virtual keyboards available in the electronic device 101. For example, the processor 120 may control the display 310 to display the virtual keyboard 360 having a layout related to the text input portion 320 using the data type indicating the corresponding element 340 related to the text input portion 320 and/or the information indicated by the corresponding element 340.

For example, the processor 120 may be configured to determine that a type of text to be input through the text input portion 320 is a number based on detecting the corresponding element 340 related to the text input portion 320. For example, the processor 120 may be configured to identify that a data type of the corresponding element 340 corresponds to a number based on detecting the corresponding element 340 related to the text input portion 320. For example, the processor 120 may be configured to identify that information indicated by the corresponding element 340 is a number based on detecting the corresponding element 340 related to the text input portion 320. Based on identifying that the information indicated by the corresponding element 340 is a number, the processor 120 may control the display 310 to display the virtual keyboard 360 corresponding to a second software keyboard 362 having a number-type layout and including a plurality of numbers 366. The second software keyboard 362 may be associated with a type of text determined by a number to be input to the text input portion 320 compared to the first software keyboard 361. However, the disclosure is not limited thereto.

For example, the processor 120 may include text input portions 421, 422, and 423 distinguished from text input portion 320. Based on a user input input through at least one of the text input portions 421, 422, and 423, the processor 120 may be configured to regenerate a hierarchical structure with respect to the at least one of the text input portions 421, 422, and 423. For example, the processor 120 may be configured to detect a region 412b in the screen 412 closest to the text input portions 421, 422, and 423 and/or elements in the region 412b, based on a user input input through at least one of the text input portions 421, 422, and 423. For example, the processor 120 may be configured to detect an element 441 related to the text input portions 421, 422, and 423 in the region 412b, a visual object 432 for authentication of text and/or a number input to the text input portions 421, 422, and 423, and a visual object 450 for transmitting information input into the screen 412 to an external electronic device (e.g., the electronic device 102 of FIG. 1). The processor 120 may be configured to identify that a type of text to be input to the text input portions 421, 422, and 423 is a number based on detecting the element 441 related to the text input portions 421, 422, and 423. The processor 120 may obtain a data type of the element 441 and/or information indicated by the element 441. Based on determining that a type of text to be input to the text input portion 320 is a number, the processor 120 may control the display 310 to display the virtual keyboard 360 corresponding to the second software keyboard 362 having a number-type layout and including the plurality of numbers 366. However, these are merely examples, and are not limited thereto.

For example, when referring to FIGS. 4C and 4D, the processor 120 may be configured to identify that a type of text to be input to the text input portion 320 is a signature based on detecting the corresponding element 340 related to the text input portion 320. Based on identifying that the type of text is a signature, the processor 120 may control the display 310 to display the virtual keyboard 360 corresponding to a board 363 having a board-type layout and configured to receive a user input through a gesture of the user and/or a stylus fan (not illustrated). For example, the board 363 may provide visual objects 461 and 462 for displaying a user input in the board 363 and a visual object 463 for deleting the user input input in the board 363. For example, the board 363 may be configured to display a visual object 470 corresponding to a user input input into the board 363 based on the visual objects 461 and 462. However, the disclosure is not limited thereto. The processor 120 of the electronic device 101 may detect the corresponding element 340 related to the text input portion 320 using the hierarchical analysis model 210, and provide the virtual keyboard 360 having various layouts related to the text input portion 320 based on a data type of the corresponding element 340 and/or information indicated by the corresponding element 340.

Hereinafter, referring to FIGS. 5 and 6, operations of the processor 120 of the electronic device 101 for providing one or more recommended words 540 and/or one or more visual objects 530 related to the text input portion 320 using the corresponding element 340 related to the text input portion 320 are described in greater detail.

FIG. 5 is a diagram illustrating an example operation of an example electronic device according to various example embodiments.

Referring to FIG. 5, an example screen 500 including a plurality of elements 330 may be displayed through a display 310 of an electronic device 101. Operations of FIG. 5 may be performed by the electronic device 101 and/or the processor 120 of the electronic device 101 of FIG. 1.

When referring to FIG. 5, based on a first user input to a text input portion 320 among t plurality of elements 330, the processor 120 may be configured to generate a hierarchical structure (e.g., the hierarchical structure 302 of FIG. 3B) for displaying the plurality of elements 330 through the display 310 with respect to the text input portion 320. Until a data element (e.g., the data element 353c of FIG. 3A) corresponding to a corresponding element 340 related to the text input portion 320 with respect to a data element (e.g., the data element 353b of FIG. 3A) corresponding to the text input portion 320 is detected, the processor 120 may be configured to detect the plurality of elements 330 displayed in a screen 500 while progressively increasing a hierarchical depth from the data element corresponding to the text input portion 320. The processor 120 may be configured to perform an operation of detecting the data element corresponding to the corresponding element 340 using a hierarchical analysis model (e.g., the hierarchical analysis model 210 of FIG. 2). The operations of detecting the data element corresponding to the corresponding element 340 may be substantially the same as or similar to the operations illustrated and described in FIGS. 3A and 3B.

According to an embodiment, the processor 120 may be configured to determine one or more recommended words (e.g., recommended words 541 and 542) related to one or more contents (e.g., an image, a video, and the like) provided by a data element (e.g., the data element 353c of FIG. 3A) related to a data element (e.g., the data element 353b of FIG. 3A) corresponding to the text input portion 320. The processor 120 may be configured to display a virtual keyboard 360 including the one or more recommended words on the display 310 together with the text input portion 320 of the screen 500.

According to an embodiment, the processor 120 may be configured to identify a data type of a data element (e.g., the data element 353c of FIG. 3A) related to a data element (e.g., the data element 353b of FIG. 3A) corresponding to the text input portion 320. The processor 120 may be configured to determine at least one subject region 510 of an image corresponding to the data element 353c based on the data type identified as an image. The processor 120 may be configured to display one or more visual objects (e.g., visual objects 531, 532, and 533) respectively indicating one or more recommended words (e.g., the recommended words 541 and 542) related to the at least one subject region 510 in a region in which the virtual keyboard 360 is displayed. For example, the at least one subject region 510 may be a region surrounding at least one visual object 520 included in an image corresponding to the corresponding element 340. For example, the at least one subject region 510 may include a subject region 511 surrounding the visual object 521 in the image, a subject region 512 surrounding a visual object 522, and a subject region 513 surrounding a visual object 523.

According to an embodiment, the processor 120 may be configured to obtain another image corresponding to the image displayed by modifying a size of an image provided from a data element 353c related to a data element 353b to a preset size related to an image analysis model. The processor 120 may be configured to detect the at least one subject region 510 of the image by executing the image analysis model using the another image. The processor 120 may be configured to display the recommended words 541 and 542 and/or the visual objects 531, 532, and 533 corresponding to the at least one visual object 520 through the virtual keyboard 360 by identifying the at least one visual object 520 (e.g., the visual objects 521, 522, and 523) included in the at least one subject region 510, using the image analysis model.

For example, the processor 120 may be configured to identify a size of an image corresponding to the corresponding element 340 displayed in the screen 500 based on identifying that a data type indicating the corresponding element 340 corresponds to an image. Based on identifying the size of the image exceeding a designated size, the processor 120 may be configured to modify the size of the image to the designated size. The processor 120 may be configured to detect the at least one visual object 520 included in the image having the size less than or equal to the designated size, using the image analysis model. Such as the hierarchical analysis model 210 of FIG. 2, the image analysis model may be provided through an electronic device 102 as a neural network, or may be driven based on a plurality of parameters included in memory (e.g., the memory 130 of FIG. 1) in the electronic device 101.

For example, based on identifying that a data type of the corresponding element 340 related to the text input portion 320 is an image, the processor 120 may be configured to identify whether the image has a size exceeding a designated size that is processable through the image analysis model. Based on identifying the image having the size exceeding the designated size, the processor 120 may be configured so as to input each image data value of the resized elements (e.g., the visual objects 521, 522, and 523 of FIG. 5) in the corresponding element 340 corresponding to the image to the image analysis model without changing the display of the corresponding element 340 in a screen. For example, based on identifying an image corresponding to the corresponding element 340 having a size less than or equal to a designated size that is processable by the image analysis model, the processor 120 may be configured to input the image to the image analysis model. The processor 120 may be configured to detect the at least one visual object 520 included in the image using the image analysis model. For example, the processor 120 may be configured to receive information related to the visual objects 521, 522, and 523 included in an image output from the image analysis model.

According to an embodiment, the processor 120 may classify the at least one visual object 520 based on detecting the at least one visual object 520 included in the corresponding element 340 using the image analysis model. The processor 120 may be configured to control the display 310 to display the one or more recommended words 540 related to the at least one visual object 520 based on the classified at least one visual object 520.

For example, the processor 120 may be configured to identify that a data type of the corresponding element 340 related to the text input portion 320 displayed in a region 500a is an image. The processor 120 may be configured to detect the visual objects 521, 522, and 523 included in the corresponding element 340 using the image analysis model. The processor 120 may classify the visual objects 521, 522, and 523 to obtain information respectively indicated by the visual objects 521, 522, and 523 by respectively classifying the visual objects 521, 522, and 523. The processor 120 may be configured to display the one or more recommended words 540 related to the visual objects 521, 522, and 523 through the display 310 using the information respectively indicated by the visual objects 521, 522, and 523.

For example, the processor 120 may be configured to display the keyword 541 related to the visual object 521 through the virtual keyboard 360 based on classifying the visual object 521 among the at least one visual object 520. For example, the processor 120 may be configured to display the keyword 542 related to the visual object 523 through the virtual keyboard 360 based on classifying the visual object 523 among the at least one visual object 520. However, the disclosure is not limited thereto.

According to an embodiment, the processor 120 may be configured to display, on the display 310, the virtual keyboard 360 including one or more executable objects 550 respectively indicating the one or more recommended words 540 in the text input portion 320. For example, the processor 120 may receive a second user input for an executable object 551 among the one or more executable objects 550. Based on the second user input, the processor 120 may be configured to display the recommended word 541 indicated by the executable object 551 in the text input portion 320 on the display 310. For example, the processor 120 may receive a second user input for an executable object 552 among the one or more executable objects 550. Based on the second user input, the processor 120 may be configured to display the recommended word 542 indicated by the executable object 552 in the text input portion 320 on the display 310. However, the disclosure is not limited thereto.

According to an embodiment, the processor 120 may be configured to control the display 310 to display one or more visual objects 530 related to the at least one visual object 520 based on the classified at least one visual object 520. For example, the processor 120 may be configured to display emoticon objects 531 and 532 related to the visual object 521 through the virtual keyboard 360 based on classifying the visual object 521 among the at least one visual object 520. For example, the processor 120 may be configured to display an emoticon object 534 related to the visual object 522 through the virtual keyboard 360 based on classifying the visual object 522 among the at least one visual object 520. For example, the processor 120 may be configured to display an emoticon object 533 related to the visual object 523 through the virtual keyboard 360 based on classifying the visual object 523 among the at least one visual object 520. However, the disclosure is not limited thereto.

FIG. 6 is a diagram illustrating an example operation of an example electronic device according to various example embodiments.

Referring to FIG. 6, an example screen 600 including a plurality of elements 330 may be displayed through a display 310 of an electronic device 101. Operations of FIG. 6 may be performed by the electronic device 101 and/or the processor 120 of the electronic device 101 of FIG. 1.

When referring to FIG. 6, based on a first user input to a text input portion 320 among a plurality of elements 330, the processor 120 may be configured to generate a hierarchical structure (e.g., the hierarchical structure 302 of FIG. 3B) for displaying the plurality of elements 330 through the display 310 with respect to the text input portion 320. Until a data element (e.g., the data element 353c of FIG. 3A) corresponding to a corresponding element 340 related to the text input portion 320 with respect to a data element (e.g., the data element 353b of FIG. 3A) corresponding to the text input portion 320 is detected, the processor 120 may be configured to detect the plurality of elements 330 displayed in a screen 600 while progressively increasing a hierarchical depth from the data element corresponding to the text input portion 320. The processor 120 may be configured to perform an operation of detecting the data element corresponding to the corresponding element 340 using a hierarchical analysis model (e.g., the hierarchical analysis model 210 of FIG. 2). The operations of detecting the data element corresponding to the corresponding element 340 may be substantially the same as or similar to the operations illustrated and described in FIGS. 3A and 3B.

According to an embodiment, the processor 120 may be configured to determine a type of text to be input to the text input portion 320 based on detecting the corresponding element 340 displayed in a region 600a of a screen 600 related to the text input portion 320. Based on identifying that a type of text to be input to the text input portion 320 is a character, the processor 120 may control the display 310 to display a virtual keyboard 360 corresponding to a first software keyboard 361 related to the text input portion 320 and having a character-type layout. The first software keyboard 361 may include, for example, at least one alphabet 365 for a text input and a plurality of numbers 366 for a number input, but is not limited thereto.

According to an embodiment, the processor 120 may be configured to display one or more contents provided from a data element corresponding to the corresponding element 340 related to the text input portion 320 through the display 310. For example, the processor 120 may control the display 310 such that a video provided from a data element corresponding to the corresponding element 340 is displayed in the region 600a.

According to an embodiment, the processor 120 may be configured to determine one or more recommended words 540 related to one or more contents provided from a data element corresponding to the corresponding element 340. The processor 120 may control the display 310 to display the virtual keyboard 360 including the one or more recommended words 540 on a screen together with the text input portion 320.

According to an embodiment, the processor 120 may be configured to receive a second user input (e.g., a touch input of a user to the virtual keyboard 360) for inputting at least one character 621 related to the text input portion 320. In response to the second user input, the processor 120 may be configured to display the one or more recommended words 540 including the at least one character 621 and related to the text input portion 320 through the display 310 using a data type indicating the corresponding element 340 and/or information indicated by the corresponding element 340.

For example, although not illustrated, before the second user input to the text input portion 320 is received, the processor 120 may be configured to display one or more other recommended words related to corresponding element 340 and distinguished from the one or more recommended words 540 through the display 310 together with the text input portion 320. The processor 120 may be configured to determine the one or more recommended words 540 using the at least one character 621 and/or the corresponding element 340 based on receiving the second user input for inputting the at least one character 621 through the text input portion 320. The processor 120 may be configured to display, on the display 310, the virtual keyboard 360 including the one or more recommended words 540 including the at least one character 621 together with the text input portion 320 including the at least one character 621. According to the display of the one or more recommended words 540, displaying a portion of the one or more other recommended words on the virtual keyboard 360 may be terminated.

For example, the processor 120 may be configured to identify that a data type of the corresponding element 340 related to the text input portion 320 displayed in the region 600a is text. The processor 120 may be configured to obtain information indicated by the detected corresponding element 340 (e.g., a meaning of the text corresponding to the corresponding element 340 or a meaning of one or more recommended words included in the corresponding element 340). The processor 120 may be configured to display the one or more recommended words 540 related to the corresponding element 340 and the text input portion 320 through the display 310 using the information.

For example, the processor 120 may provide recommended words 641 and 642 related to the corresponding element 340 and the text input portion 320 and including the at least one character 621 through the virtual keyboard 360, using the information indicated by the corresponding element 340. However, the disclosure is not limited thereto.

For example, based on receiving the second user input for inputting the at least one character 621 related to the text input portion 320, the processor 120 may be configured to display one or more visual objects 530 related to the one or more recommended words 540 and/or the corresponding element 340 through the display 310 together with the one or more recommended words 540 including the at least one character 621. For example, the processor 120 may be configured to display emoticon objects 631, 632, 633, and 634 related to the corresponding element 340 through the virtual keyboard 360 based on identifying the information indicated by the corresponding element 340. However, the disclosure is not limited thereto.

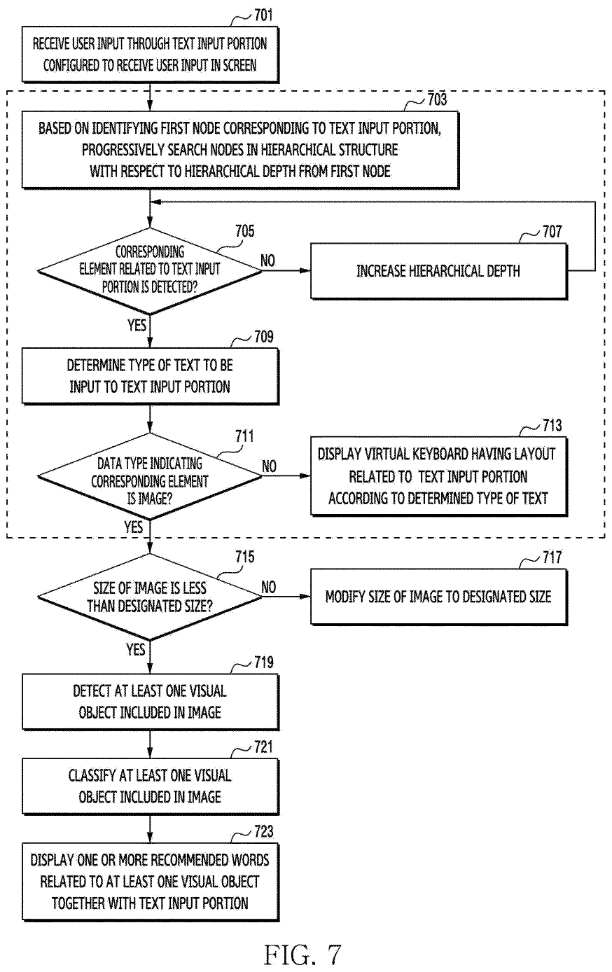

FIG. 7 is a flowchart illustrating an example operation of an example electronic device according to various example embodiments.

Operations of FIG. 7 may be performed by an electronic device 101 and/or the processor 120 of the electronic device 101 of FIG. 1.

Referring to FIG. 7, in operation 701, the processor 120 may be configured to receive a first user input through a text input portion (e.g., the text input portion 320 of FIG. 3A) configured to receive a user input in a screen displayed through a display (e.g., the display 310 of FIG. 3A). For example, the processor 120 may be configured to identify a user input related to the text input element 320 based on a touch input of a user to a region in the screen on which the text input portion 320 is displayed.

In operation 703, based on identifying a first data element (e.g., the data element 353b in FIG. 3A) corresponding to the text input portion 320, the processor 120 may be configured to progressively search data elements in a hierarchical structure (e.g., the hierarchical structure 301 of FIG. 3A and/or the hierarchical structure 302 of FIG. 3B) for a hierarchical depth from the first data element 353b. For example, the processor 120 may be configured to generate a hierarchical structure (e.g., the hierarchical structure 302 of FIG. 3B) in which the first data element 353b corresponding to the text input portion 320 is set as a root data element based on a user input to the text input portion 320. For example, the processor 120 may be configured to detect a second data element (e.g., the data element 353c of FIG. 3A) having relatively high relevance to the first data element 353b among data elements corresponding to each of a plurality of elements (e.g., the plurality of elements 330 of FIG. 3A) in the hierarchical structure 302, using a hierarchical analysis model (e.g., the hierarchical analysis model 210 of FIG. 2A).

In operation 705, the processor 120 may be configured to identify whether a corresponding element 340 related to the text input portion 320 has been detected. For example, when referring to FIG. 3B together, the processor 120 may be configured to first detect elements corresponding to data elements closest to the data element 353b corresponding to the text input portion 320 in the hierarchical structure 302 generated based on a user input. Based on relevance to the text input portion 320, the processor 120 may be configured to identify whether the corresponding element 340 having relevance greater than or equal to designated relevance to the text input portion 320 is detected. The processor 120 may perform operation 707 when failing to detect the corresponding element 340 (e.g., 705-No).

In operation 707, the processor 120 may increase a hierarchical depth for searching a plurality of elements 330. For example, when referring to FIG. 3B, the processor 120 may detect a region 300a corresponding to a data element 353a positioned in a first hierarchical depth from the data element 353b corresponding to the text input portion 320. By increasing a hierarchical depth based on identifying that the corresponding element 340 is not detected in the region 300b, the processor 120 may detect the region 300a corresponding to a data element 352a positioned in a second hierarchical depth greater than the first hierarchical depth from the data element 353b corresponding to the text input portion 320.

In operation 709, the processor 120 may be configured to determine a type of text to be input to the text input portion 320 based on detecting the corresponding element 340 related to the text input portion 320. For example, the processor 120 may be configured to determine a type of text (e.g., a number or a character) to be input to the text input portion 320 based on the corresponding element 340 and/or a data element 353c corresponding to the corresponding element 340.

In operation 711, the processor 120 may be configured to identify a data type indicating the corresponding element 340 and information indicated by the corresponding element 340 based on detecting the corresponding element 340. For example, the processor 120 may be configured to obtain a data type of the corresponding element 340 and information included in the corresponding element 340 based on detecting the corresponding element 340. For example, the processor 120 may be configured to identify whether a data type indicating the corresponding element 340 is an image. For example, based on identifying that the data type indicating the corresponding element 340 is not an image, the processor 120 may be configured to identify that the data type indicating the corresponding element 340 is text or a number. The processor 120 may perform operation 713 when failing to identify that the data type is an image (e.g., 711-No).

In operation 713, the processor 120 may be configured to display a virtual keyboard (e.g., the virtual keyboard 360 of FIG. 3A) having a layout related to the text input portion 320 according to the type of text determined based on the corresponding element 340. For example, the processor 120 may be configured to display a first software keyboard (e.g., the first software keyboard 361 of FIG. 3A) having a character-type layout based on determining that a type of text to be input to the text input portion 320 through the corresponding element 340 is a character. For example, the processor 120 may be configured to display a second software keyboard (e.g., the second software keyboard 362 of FIG. 4B) having a number-type layout based on determining that a type of text to be input to the text input portion 320 through the corresponding element 340 is a number.

In operation 715, based on identifying that a data type of the corresponding element 340 is an image, the processor 120 may be configured to identify whether a size of the image is less than a designated size. For example, the processor 120 may be configured to identify whether an image has a size exceeding a designated size that is processable through an image analysis model. The processor 120 may perform operation 719 when identifying the image having the size less than the designated size (e.g., 715-Yes). The processor may perform operation 717 when identifying the image having the size exceeding or equal to the designated size (e.g., 715-No).

In operation 717, the processor 120 may be configured to modify the size of the image to the designated size based on identifying that the size of the image corresponding to the corresponding element 340 exceeds the designated size (or based on identifying that the size of the image is not less than the designated size). For example, the processor 120 may be configured to modify the size of the image to the designated size that is processable through the image analysis model based on identifying that the size of the image exceeds the designated size.

In operation 719, the processor 120 may be configured to detect at least one visual object (e.g., the at least one visual object 520 of FIG. 5) included in the corresponding element 340. For example, the processor 120 may be configured to identify at least one visual object 520 included in the image corresponding to the corresponding element 340 output through the image analysis model.

In operation 721, the processor 120 may be configured to classify the at least one visual object 520 included in the corresponding element 340. For example, the processor 120 may be configured to obtain information on each of the at least one visual object 520 based on identifying the at least one visual object 520 included in the corresponding element 340. The processor 120 may be configured to classify the at least one visual object 520 using the obtained information of the at least one visual object 520.

In operation 723, the processor 120 may be configured to display one or more recommended words (e.g., the one or more recommended words 540 of FIG. 5) related to the at least one visual object 520 together with the text input portion 320 using an image including the at least one visual object 520 based on the classified at least one visual object 520. For example, when referring to FIG. 5 together, the processor 120 may provide recommended words 541 and 542 related to the at least one visual object 520 based on the at least one visual object 520 included in the corresponding element 340.

An electronic device (e.g., the electronic device 101 of FIG. 1) according to an example embodiment may include a display (e.g., the display 310 of FIG. 3A), at least one processor (e.g., the processor 120 of FIG. 1) including processing circuitry, and memory (e.g., the memory 130 of FIG. 1) including one or more storage media storing instructions. The instructions, when executed, individually or collectively, by the at least one processor, may cause the electronic device to display, on the display, a screen generated based on data elements arranged in a hierarchical structure (e.g., the hierarchical structure 301 of FIG. 3A). The instructions, when executed, individually or collectively, by the at least one processor, may cause the electronic device to receive an input to a text input portion (e.g., the text input portion 320 of FIG. 3A) in the displayed screen. The instructions, when executed, individually or collectively, by the at least one processor, may cause the electronic device to, based on the input, identify a first data element (e.g., the data element 353b of FIG. 3A) corresponding to the text input portion among the data elements arranged in the hierarchical structure. The instructions, when executed, individually or collectively, by the at least one processor, may cause the electronic device to identify a second data element (e.g., the data element 353c of FIG. 3A) related to the first data element among the data elements arranged in the hierarchical structure. The instructions, when executed, individually or collectively, by the at least one processor, may cause the electronic device to, based on the second data element, determine a type of text to be input through the text input portion. The instructions, when executed, individually or collectively, by the at least one processor, may cause the electronic device to display, on the display, a virtual keyboard (e.g., the virtual keyboard 360 of FIG. 3A) together with the text input portion of the screen according to the determined type of text.

For example, the instructions, when executed, individually or collectively, by the at least one processor, may cause the electronic device to, based on progressively searching the data elements with respect to a hierarchical depth from the first data element, identify the second data element.

For example, the instructions, when executed, individually or collectively, by the at least one processor, may cause the electronic device to, identify the second data element by determining whether a data element having a first hierarchical depth from the first data element among the data elements is related to the first data element, based on determining that the data element is related to the first data element, identifying the data element as the second data element, and based on determining that the data element is not related to the first data element, determining whether another data element having a second hierarchical depth from the first data element is related to the first data element. The second hierarchical depth may be greater than the first hierarchical depth.

For example, the instructions, when executed, individually or collectively, by the at least one processor, may cause the electronic device to, using a hierarchical analysis model (e.g., the hierarchical analysis model 210 of FIG. 2), identify the second data element based on relevance between the first data element and the second data element determined by the hierarchical analysis model.

For example, the instructions, when executed, individually or collectively, by the at least one processor, may cause the electronic device to, based on the input, generate an additional hierarchical structure including the data elements by modifying the hierarchical structure based on the first data element, wherein the first data element in the additional hierarchical structure may be set as a root data element. The instructions, when executed, individually or collectively, by the at least one processor, may cause the electronic device to, using the additional hierarchical structure, identify the second data element.

For example, the instructions, when executed, individually or collectively, by the at least one processor, may cause the electronic device to identify the virtual keyboard corresponding to the type of text among virtual keyboards available in the electronic device. The instructions, when executed, individually or collectively, by the at least one processor, may cause the electronic device to display, on the display, the virtual keyboard corresponding to the type of text together with the text input portion of the screen. The virtual keyboard among the virtual keyboards may be associated with the type of text compared to one or more remaining virtual keyboards.

For example, the instructions, when executed, individually or collectively, by the at least one processor, may cause the electronic device to display, on the display, the screen by executing a first software application generating the hierarchical structure of the data elements. The instructions, when executed, individually or collectively, by the at least one processor, may cause the electronic device to, based on the input, execute a second software application to display the virtual keyboard superimposed on the screen. The instructions, when executed, individually or collectively, by the at least one processor, may cause the electronic device to, based on executing the second software application, identify the second data element among the data elements arranged in the hierarchical structure generated by the first software application.

An electronic device according to an example embodiment may include a display, at least one processor including processing circuitry, and memory including one or more storage media storing instructions. The instructions, when executed, individually or collectively, by the at least one processor, may cause the electronic device to display, on the display, a screen generated based on data elements arranged in a hierarchical structure. The instructions, when executed, individually or collectively, by the at least one processor, may cause the electronic device to receive an input to a text input portion in the displayed screen. The instructions, when executed, individually or collectively, by the at least one processor, may cause the electronic device to, based on the input, identify a first data element corresponding to the text input portion among the data elements arranged in the hierarchical structure. The instructions, when executed, individually or collectively, by the at least one processor, may cause the electronic device to identify a second data element related to the first data element among the data elements arranged in the hierarchical structure. The instructions, when executed, individually or collectively, by the at least one processor, may cause the electronic device to determine one or more recommended words (e.g., the one or more recommended words 540 of FIG. 5) related to one or more contents provided by the second data element. The instructions, when executed, individually or collectively, by the at least one processor, may cause the electronic device to display, on the display, a virtual keyboard including the one or more recommended words together with the text input portion of the screen.

For example, the instructions, when executed, individually or collectively, by the at least one processor, may cause the electronic device to, based on progressively searching the data elements with respect to a hierarchical depth from the first data element, identify the second data element.

For example, the instructions, when executed, individually or collectively, by the at least one processor, may cause the electronic device to identify the second data element by determining whether a data element having a first hierarchical depth from the first data element among the data elements is related to the first data element, based on determining that the data element is related to the first data element, identifying the data element as the second data element, and based on determining that the data element is not related to the first data element, determining whether another data element having a second hierarchical depth from the first data element is related to the first data element. The second hierarchical depth may be greater than the first hierarchical depth.

For example, the instructions, when executed, individually or collectively, by the at least one processor, may cause the electronic device to, using a hierarchical analysis model, identify the second data element.

For example, the instructions, when executed, individually or collectively, by the at least one processor, may cause the electronic device to, while the virtual keyboard including the one or more recommended words is displayed, identify at least one character (e.g., the at least one character 621 of FIG. 6) input to the text input portion through the virtual keyboard. The instructions, when executed, individually or collectively, by the at least one processor, may cause the electronic device to, using the at least one character and the one or more contents, determine one or more other recommended words. The instructions, when executed, individually or collectively, by the at least one processor, may cause the electronic device to display, on the display, the virtual keyboard including the one or more other recommended words together with the text input portion including the at least one character of the screen. According to the display of the one or more other recommended words, displaying a portion of the one or more recommended words on the virtual keyboard may be terminated.

For example, the instructions, when executed, individually or collectively, by the at least one processor, may cause the electronic device to display, on the display, the virtual keyboard including one or more executable objects (e.g., the one or more executable objects 550 of FIG. 5) respectively indicating the one or more recommended words for the text input portion. The instructions, when executed, individually or collectively, by the at least one processor, may cause the electronic device to receive another input to an executable object among the one or more executable objects. The instructions, when executed, individually or collectively, by the at least one processor, may cause the electronic device to, based on the another input, display the recommended word indicated by the executable object in the text input portion on the display.

For example, the instructions, when executed, individually or collectively, by the at least one processor, may cause the electronic device to identify a data type of the second data element. The instructions, when executed, individually or collectively, by the at least one processor, may cause the electronic device to, based on the data type identified as an image, determine at least one subject region (e.g., the at least one subject region 510 of FIG. 5) of an image corresponding to the second data element, and display, in a region where the virtual keyboard is displayed, one or more visual objects (e.g., the one or more visual objects 530 of FIG. 5) respectively indicating the one or more recommended words related to the at least one subject region.

For example, the instructions, when executed, individually or collectively, by the at least one processor, may cause the electronic device to, based on the data type identified as an image, obtain another image corresponding to the image displayed by modifying a size of the image to a preset size related to the image analysis model, and to detect the at least one subject region by executing the image analysis model using the another image.

A method of operating an electronic device according to an example embodiment may include displaying, on a display of the electronic device, a screen generated based on data elements arranged in a hierarchical structure. The method may include receiving an input to a text input portion in the displayed screen. The method may include, based on the input, identifying a first data element corresponding to the text input portion among the data elements arranged in the hierarchical structure. The method may include identifying a second data element related to the first data element among the data elements arranged in the hierarchical structure. The method may include, based on the second data element, determining a type of text to be input through the text input portion. The method may include displaying, on the display, a virtual keyboard together with the text input portion of the screen according to the determined type of text.

For example, the method may further include, based on progressively searching the data elements with respect to a hierarchical depth from the first data element, identifying the second data element.

For example, the method may further include identifying the second data element by determining whether a data element having a first hierarchical depth from the first data element among the data elements is related to the first data element, based on determining that the data element is related to the first data element, identifying the data element as the second data element, and based on determining that the data element is not related to the first data element, determining whether another data element having a second hierarchical depth from the first data element is related to the first data element. The second hierarchical depth may be greater than the first hierarchical depth.

For example, the method may further include, using a hierarchical analysis model, identifying the second data element.

According to an example embodiment, in a non-transitory computer readable storage medium storing one or more programs, the one or more programs may include instructions which, when executed by at least one processor of an electronic device with a display, cause the electronic device to display, on the display, a screen generated based on data elements arranged in a hierarchical structure. The one or more programs may include instructions which, when executed by the at least one processor, cause the electronic device to receive an input to a text input portion in the displayed screen. The one or more programs may include instructions which, when executed by the at least one processor, cause the electronic device to, based on the input, identify a first data element corresponding to the text input portion among the data elements arranged in the hierarchical structure. The one or more programs may include instructions which, when executed by the at least one processor, cause the electronic device to identify a second data element related to the first data element among the data elements arranged in the hierarchical structure. The one or more programs may include instructions which, when executed by the at least one processor, cause the electronic device to, based on the second data element, determine a type of text to be input through the text input portion. The one or more programs may include instructions which, when executed by the at least one processor, cause the electronic device to display, on the display, a virtual keyboard together with the text input portion of the screen according to the determined type of text.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a display;
at least one processor comprising processing circuitry; and
memory comprising one or more storage media storing instructions,
wherein the instructions, when executed, individually or collectively, by the at least one processor, cause the electronic device to:
display, on the display, a screen generated based on data elements arranged in a hierarchical structure;
receive an input to a text input portion in the displayed screen;
based on the input, identify a first data element corresponding to the text input portion among the data elements arranged in the hierarchical structure;
identify a second data element related to the first data element among the data elements arranged in the hierarchical structure;
based on the second data element, determine a type of text to be input through the text input portion; and
display, on the display, a virtual keyboard together with the text input portion of the screen according to the determined type of text.

2. The electronic device of claim 1,
wherein the instructions, when executed, individually or collectively, by the at least one processor, cause the electronic device to:
based on progressively searching the data elements with respect to a hierarchical depth from the first data element, identify the second data element.

3. The electronic device of claim 1,
wherein the instructions, when executed, individually or collectively, by the at least one processor, cause the electronic device to:
identify the second data element by:
determining whether a data element having a first hierarchical depth from the first data element among the data elements is related to the first data element;
based on determining that the data element is related to the first data element, identifying the data element as the second data element; and
based on determining that the data element is not related to the first data element, determining whether another data element having a second hierarchical depth from the first data element is related to the first data element,
wherein the second hierarchical depth is greater than the first hierarchical depth.

4. The electronic device of claim 1,
wherein the instructions, when executed, individually or collectively, by the at least one processor, cause the electronic device to:
using a hierarchical analysis model, identify the second data element based on relevance between the first data element and the second data element determined by the hierarchical analysis model,
wherein the relevance is output from the hierarchical analysis model based on a referential relationship between the first data element and the second data element.

5. The electronic device of claim 1,
wherein the instructions, when executed, individually or collectively, by the at least one processor, cause the electronic device to:
based on the input, generate an additional hierarchical structure comprising the data elements by modifying the hierarchical structure based on the first data element, wherein the first data element in the additional hierarchical structure is set as a root data element; and
using the additional hierarchical structure, identify the second data element.

6. The electronic device of claim 1,
wherein the instructions, when executed, individually or collectively, by the at least one processor, cause the electronic device to:
identify the virtual keyboard corresponding to the type of text among virtual keyboards available in the electronic device; and
display, on the display, the virtual keyboard corresponding to the type of text together with the text input portion of the screen,
wherein the virtual keyboard among the virtual keyboards is associated with the type of text compared to one or more remaining virtual keyboards.

7. The electronic device of claim 1,
wherein the instructions, when executed, individually or collectively, by the at least one processor, cause the electronic device to:
display, on the display, the screen by executing a first software application generating the hierarchical structure of the data elements;
based on the input, execute a second software application to display the virtual keyboard superimposed on the screen; and
based on executing the second software application, identify the second data element among the data elements arranged in the hierarchical structure generated by the first software application.

8. An electronic device comprising:
a display;
at least one processor comprising processing circuitry; and
memory comprising one or more storage media storing instructions,
wherein the instructions, when executed, individually or collectively, by the at least one processor, cause the electronic device to:
display, on the display, a screen generated based on data elements arranged in a hierarchical structure;
receive an input to a text input portion in the displayed screen;
based on the input, identify a first data element corresponding to the text input portion among the data elements arranged in the hierarchical structure;
identify a second data element related to the first data element among the data elements arranged in the hierarchical structure;
determine one or more recommended words related to one or more contents provided by the second data element; and
display, on the display, a virtual keyboard comprising the one or more recommended words together with the text input portion of the screen.

9. The electronic device of claim 8,
wherein the instructions, when executed, individually or collectively, by the at least one processor, cause the electronic device to:
based on progressively searching the data elements with respect to a hierarchical depth from the first data element, identify the second data element.

10. The electronic device of claim 8,
wherein the instructions, when executed, individually or collectively, by the at least one processor, cause the electronic device to:
identify the second data element by:
determining whether a data element having a first hierarchical depth from the first data element among the data elements is related to the first data element;
based on determining that the data element is related to the first data element, identifying the data element as the second data element; and
based on determining that the data element is not related to the first data element, determining whether another data element having a second hierarchical depth from the first data element is related to the first data element,
wherein the second hierarchical depth is greater than the first hierarchical depth.

11. The electronic device of claim 8,
wherein the instructions, when executed, individually or collectively, by the at least one processor, cause the electronic device to:
using a hierarchical analysis model, identify the second data element;
identify a data type of the second data element;
based on the data type identified as an image, determine at least one subject region of an image corresponding to the second data element; and
display, in a region where the virtual keyboard is displayed, one or more visual objects respectively indicating the one or more recommended words related to the at least one subject region.

12. The electronic device of claim 8,
wherein the instructions, when executed, individually or collectively, by the at least one processor, cause the electronic device to:
while the virtual keyboard comprising the one or more recommended words is displayed, identify at least one character input to the text input portion through the virtual keyboard;
using the at least one character and the one or more contents, determine one or more other recommended words; and
display, on the display, the virtual keyboard comprising the one or more other recommended words together with the text input portion comprising the at least one character of the screen,
wherein according to the display of the one or more other recommended words, displaying a portion of the one or more recommended words on the virtual keyboard is terminated.

13. The electronic device of claim 8,
wherein the instructions, when executed, individually or collectively, by the at least one processor, cause the electronic device to:
display, on the display, the virtual keyboard comprising one or more executable objects respectively indicating the one or more recommended words for the text input portion;
receive another input to an executable object among the one or more executable objects; and
based on the another input, display the recommended word indicated by the executable object in the text input portion on the display.

14. A method of an electronic device, the method comprising:
displaying, on a display of the electronic device, a screen generated based on data elements arranged in a hierarchical structure;
receiving an input to a text input portion in the displayed screen;
based on the input, identifying a first data element corresponding to the text input portion among the data elements arranged in the hierarchical structure;
identifying a second data element related to the first data element among the data elements arranged in the hierarchical structure;
based on the second data element, determining a type of text to be input through the text input portion; and
displaying, on the display, a virtual keyboard together with the text input portion of the screen according to the determined type of text.

15. The method of claim 14, comprising:
based on progressively searching the data elements with respect to a hierarchical depth from the first data element, identifying the second data element.

16. The method of claim 14, comprising:
identifying the second data element by:
determining whether a data element having a first hierarchical depth from the first data element among the data elements is related to the first data element;
based on determining that the data element is related to the first data element, identifying the data element as the second data element; and
based on determining that the data element is not related to the first data element, determining whether another data element having a second hierarchical depth from the first data element is related to the first data element,
wherein the second hierarchical depth is greater than the first hierarchical depth.

17. The method of claim 14, comprising:
using a hierarchical analysis model, identifying the second data element based on relevance between the first data element and the second data element determined by the hierarchical analysis model,
wherein the relevance is output from the hierarchical analysis model based on a referential relationship between the first data element and the second data element.

18. The method of claim 14, comprising:
based on the input, generating an additional hierarchical structure comprising the data elements by modifying the hierarchical structure based on the first data element, wherein the first data element in the additional hierarchical structure is set as a root data element; and
using the additional hierarchical structure, identifying the second data element.

19. The method of claim 14, comprising:
identifying the virtual keyboard corresponding to the type of text among virtual keyboards available in the electronic device; and
displaying, on the display, the virtual keyboard corresponding to the type of text together with the text input portion of the screen,
wherein the virtual keyboard among the virtual keyboards is associated with the type of text compared to one or more remaining virtual keyboards.

20. A non-transitory computer readable storage medium storing one or more programs, wherein the one or more programs include instructions which, when executed by at least one processor of an electronic device with a display, cause the electronic device to:
display, on the display, a screen generated based on data elements arranged in a hierarchical structure;
receive an input to a text input portion in the displayed screen;
based on the input, identify a first data element corresponding to the text input portion among the data elements arranged in the hierarchical structure;
identify a second data element related to the first data element among the data elements arranged in the hierarchical structure;
based on the second data element, determine a type of text to be input through the text input portion; and
display, on the display, a virtual keyboard together with the text input portion of the screen according to the determined type of text.
